(19) United States
(12) Patent Application Publication
(10) Pub. No.: US 2009/0101446 A1
(43) Pub. Date: Apr. 23, 2009

(54) MOBILE ASSEMBLY AND MAINTENANCE CENTRE FOR MOTOR VEHICLES

(76) Inventor: Jean-Luc Franchi, Pertuis Cedex (FR)

Correspondence Address: JAMES C. LYDON, 100 DAINGERFIELD ROAD, SUITE 100, ALEXANDRIA, VA, 22314, US

(21) Appl. No.: 12/297,431

(22) PCT Filed: Apr. 16, 2007
(86) PCT No.: PCT/FR2007/000636

§ 371 Date: Oct. 16, 2008

(30) Foreign Application Priority Data
Apr. 18, 2006 (FR) 0603403

(51) Int. Cl. B66F 7/00; G06Q 30/00; B66F 9/00

(52) U.S. Cl. 187/203; 705/16

(57) ABSTRACT

A mobile mounting and maintenance center intended to be set up on a free space such as a parking lot of a hypermarket in order to carry out the mounting of tires and the peripheral maintenance of automobiles. The center comprises a first stall (10) and a second stall (12) connected by a roof (14) and separated by a space under the roof in which an automobile is positioned, which first stall is constituted by a first zone for the mounting of tires on the automobile and by a second zone for carrying out operations of peripheral maintenance on another automobile at the same time.

### TECHNICAL AREA

The present invention relates to the peripheral maintenance of automobiles carried out in specialized structures such as the centers for maintenance and repair located in the vicinity of hypermarkets and relates in particular to a center for the mobile mounting and maintenance of automobiles.

### STATE OF THE ART

For the operations of peripheral maintenance such as the mounting of tires or oil changes there is, aside from the classic garage mechanics, centers of maintenance and/or of repair situated close to hypermarkets and generally in the vicinity of parking lots.

However, these centers of mounting and maintenance are fixed, non-modular and therefore immovable. Furthermore, under pressure from hard discount groups, the hypermarkets have the tendency to get rid of their auto centers for commercial reasons but also for the reason that was mentioned, namely, the immovable nature of these centers.

In order to rapidly carry out the mounting of tires on automobiles a solution was to use a relatively large truck such as a semi-trailer truck that moves upon demand and sets itself up on the parking lot of the hypermarket. Unfortunately, the mounting of tires is carried out outdoors with all the disadvantages present during inclement weather.

### EXPOSITION OF THE INVENTION

This is why the problem of the invention is to realize a mounting and maintenance center that is mobile and at the same time permits the operations of mounting or maintenance sheltered from bad weather.

Therefore, the subject matter of the invention is a mobile mounting and maintenance center intended to be set up on a free space such as a parking lot of a hypermarket in order to carry out the mounting of tires and the peripheral maintenance of automobiles. The center comprises a first stall and a second stall connected by a roof and separated by a covered space in which an automobile is positioned, which first stall is constituted by a first zone for the mounting of tires on the automobile and by a second zone for carrying out operations of peripheral maintenance on another automobile at the same time.

### BRIEF DESCRIPTION OF THE FIGURES

The problems, subject matter and characteristics of the invention will appear more clearly from a reading of the following description which refers to the drawings in which:

FIG. 1 schematically represents a perspective view of the mounting and maintenance center in accordance with the invention, and

FIG. 2 represents a section of the mounting and maintenance center in accordance with the invention showing the different functional parts of the center.

### DETAILED DESCRIPTION OF THE INVENTION

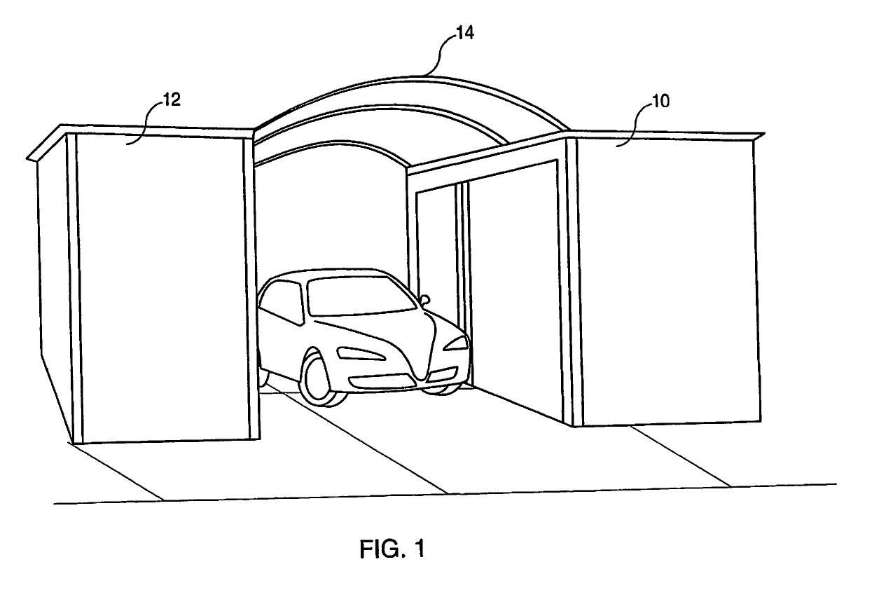

The mounting and maintenance center illustrated in FIG. 1 is composed of two stalls 10 and 12 with a length of approximately 6 m and a width of approximately 2.40 m installed on a parking lot of a distribution hypermarket, simply placed on the ground or provided with the means for moving on wheels that permits an easy moving.

The two stalls 10 and 11 are separated by a distance of approximately 4 m and are connected to each other at their top by a roof 14 which shelters the open space between the two stalls from intemperate weather. As can be seen in the figure, an automobile that needs maintenance can readily penetrate into this space.

Note that the dimensions of the mobile mounting and maintenance center can be different from those mentioned above. In particular, the two stalls 10 and 12 can not have the same width. However, too large a structure would be detrimental to the mobility, that must remain the priority objective.

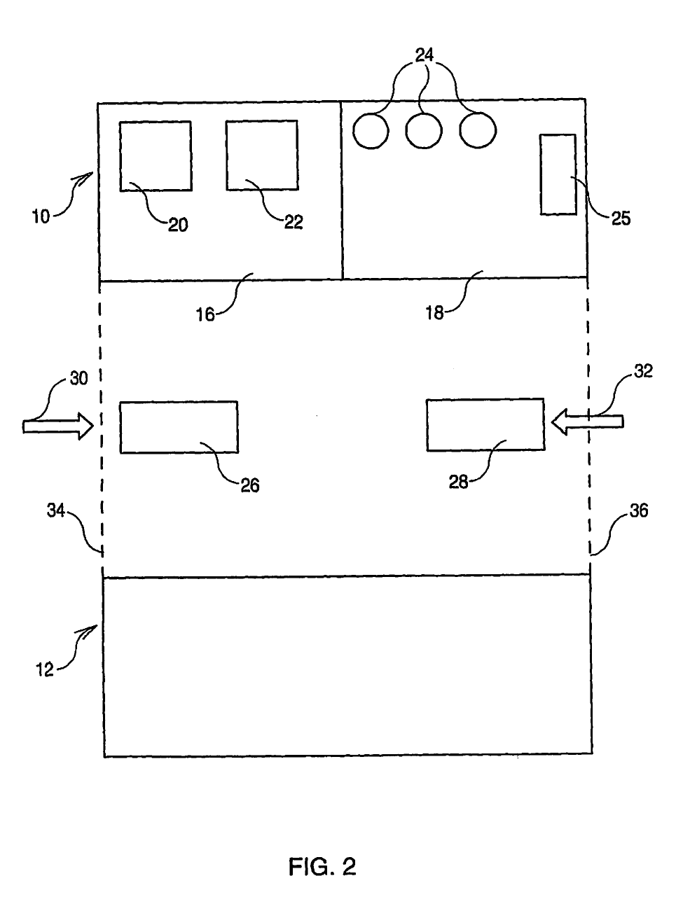

Referring to FIG. 2, the two stalls 10 and 12 have different functionalities. When the first stall 10 is used for the mounting and the maintenance, the second stall 12 is used principally for storage, for example, the storage of tires.

The first stall 10 is divided into two zones, each closed by a door, a first zone 16 where the mounting of tires on wheels is carried out and a zone 18 where the peripheral maintenance of the vehicle is carried out, which can be an oil change, checking the brakes, checking the suspension, the exhaust and the fixing of various accessories.

In zone 16 for the mounting of tires a mounting station 20 and a tire balancing station 22 are located.

In maintenance zone 18 cans of oil and other liquids are present. These cans are preferably 220 liter cans provided with boosters that permit the automatic distribution of oils, brake liquid and washing liquid. The maintenance zone also comprises a compressor 25 intended to feed a distribution system for compressed air under pipes fixed to the ceiling for distributing the pressure necessary for the functioning of the tools.

Two car lifts 26 and 28 are located in the space between the two stalls 10 and 12 and are self-stabilized lifts because they are not fixed to the floor. Lift 26 serves for the dismounting and mounting of wheels for mounting tires on them in zone 16 whereas lift 28 is used for maintenance work carried out on the vehicle in association with zone 18.

Due to the two car lifts 26 and 28 two vehicles can be received at the same time, the first vehicle that enters into the center in the direction of arrow 30 for a mounting of tires and a second vehicle that enters into the center in the direction of arrow 32 in order to have maintenance performed.

Although roof 14 could have any form, it is preferable if it is convex as shown in FIG. 1 in such a manner as to create sufficient space on top when the vehicle is in elevated position due to one of the car lifts. Note that when the center is disassembled the roof is readily retracted into storage stall 12.

According to a particular embodiment each stall is provided with a pallet truck installed at each end. The pallet trucks are welded and bolted on traverses added under the stall floor. In high position the pallet trucks permit the transport of the two stalls to the desired emplacement. Once the stalls are installed, the pallet trucks are placed in low position, the transport handles of the pallet trucks are retracted for safety reasons and the base is secured with the aid of a padlocked pin.

In order to avoid thefts that might take place in the night the center is closed by sliding doors 34, 36 shown in dotted lines in FIG. 2.

When a customer wants a tire change or maintenance, the center employee gives him an order ticket. The customer presents it for payment at a special cash register of the hypermarket. As soon as the payment has been made, an electronic message is sent via the Internet by the cash register to the mobile mounting and maintenance center indicating to its employee that the services requested can be done.

Note that the stock requirements are tracked by a barcode reader connected to a central establishment by a wireless connection such as a GPRS connection or the like.

1-10. (canceled)

11. A mobile mounting and maintenance center intended to be set up on a free space such as a parking lot of a hypermarket in order to carry out the mounting of tires and the peripheral maintenance of automobiles, which center comprises a first stall and a second stall connected by a roof and separated by a covered space in which an automobile is positioned, which first stall is constituted by a first zone for the mounting of tires on the automobile and by a second zone for carrying out operations of peripheral maintenance on another automobile at the same time.

12. The mobile center of claim 11, wherein said covered space comprises a first car lift for dismounting and mounting of wheels for mounting tires on them in said first zone and further comprises a second car lift for maintenance work on a vehicle in said second zone.

13. The mobile center of claim 12, wherein said roof is convex in order to create sufficient space when a vehicle is in an elevated position and supported by a car lift.

14. The mobile center of claim 11, wherein said roof is adapted to retract into a stall during disassembly of the mobile center.

15. The mobile center of claim 11, wherein said second zone further comprises a compressor for feeding a system for the distribution of compressed air via pipes fixed to a ceiling.

16. The mobile center of claim 11, wherein said second zone comprises 220 liter cans provided with boosters that permit automatic distribution of oils, brake liquid and washing liquid.

17. The mobile center of claim 16, comprising a barcode reader connected to a central establishment in such a manner as to follow the stock requirements of the mobile center by a wireless connection.

18. The mobile center of claim 17, wherein said wireless connection is a GPRS connection.

19. The mobile center of claim 11, wherein each of the stalls is provided with wheel movement means for moving the mobile center to a selected location.

20. The mobile center of claim 19, wherein each of the stalls comprises a pallet truck fixed at each of its ends, which pallet trucks are placed in a raised position to move the mobile center to a selected location and placed in a low position when the mobile center is located in said selected location.

20. A procedure for the mounting and maintenance of automobiles in a hypermarket using a mobile center of claim 11, comprising:
handing an order ticket to a customer by the mobile center,
presenting the order ticket for payment by the customer to a cash register of the hypermarket,
transmitting by this cash register of an electronic message via the Internet to said mobile center to authorize the services requested as soon as payment has been made, and
performing the requested services by said mobile center.
